(19) United States
(12) Patent Application Publication
(10) Pub. No.: US 2026/0192245 A1
(43) Pub. Date: Jul. 9, 2026

(54) POST-COMBUSTION CARBON CAPTURE BY CO2 DESUBLIMATION

(71) Applicant: INDUSTRIAL CLIMATE SOLUTIONS INC., Calgary (CA)

(72) Inventor: Christophe Benquet, Idron (FR)

(21) Appl. No.: 19/011,212

(22) Filed: Jan. 6, 2025

(51) Int. Cl. B01D 53/62; B01D 7/00

(52) U.S. Cl. CPC B01D 53/62; B01D 7/00; B01D 2257/504; B01D 2258/0283

(57) ABSTRACT

An apparatus for capturing a gas component from a gas mixture includes a co-current direct contact cooling chamber configured to form solid particles of the gas component by direct contact of a cryogenic liquid with the gas mixture, the co-current direct contact cooling chamber being configured to receive the gas mixture from a source of the gas mixture and to receive the cryogenic liquid from a supply of the cryogenic liquid. The apparatus also includes a separator coupled to an output of the co-current direct contact cooling chamber and configured to separate the solid particles of the gas component from a fluid mixture exiting the direct contact cooling chamber with the solid particles of the gas component to capture the gas component from the gas mixture.

### BACKGROUND

Climate change refers to global warming, which is the ongoing increase in global average temperature, and its effects on the Earth's climate system. One suspected cause of climate change is the release of greenhouse gases such as carbon dioxide into the Earth's atmosphere. Consequently, universal efforts are ongoing to reduce carbon dioxide emissions. One way to reduce carbon dioxide emissions is to capture the carbon dioxide from flue gases released by combustion of fossil fuels. Solvent-based technologies are a known way to capture carbon dioxide from post-combustion gases. Unfortunately, there are several disadvantages with using the solvent-based technology. For example, the solvent in the solvent-based technologies may degrade with use and harmful components may be released to the atmosphere with this technology. Also, the solvent needs to be heated to recover the carbon dioxide with the associated need for the heat energy. The carbon dioxide released from the solvent is recovered in the gas phase and requires compressors and the associated energy to increase the pressure of the gas for transport. Alternatively, the recovered carbon dioxide is liquified to be transported in a dense phase requiring compression and low temperature. Hence, it would be well received by carbon capture industries, industries producing post-combustion gases and industrial CO₂ emitters if new techniques were developed to capture carbon dioxide with reduced energy requirements and reduced atmospheric emissions of harmful components.

### BRIEF SUMMARY

Disclosed is an apparatus for capturing a gas component from a gas mixture. The apparatus includes a co-current direct contact cooling chamber configured to form solid particles of the gas component by direct contact of a cryogenic liquid with the gas mixture, the co-current direct contact cooling chamber being configured to receive the gas mixture from a source of the gas mixture and to receive the cryogenic liquid from a supply of the cryogenic liquid. The apparatus also includes a separator coupled to an output of the direct contact cooling chamber and configured to separate the solid particles of the gas component from a fluid mixture exiting the co-current direct contact cooling chamber with the solid particles of the gas component to capture the gas component from the gas mixture.

Also disclosed is a method for capturing a gas component from a gas mixture. The method includes receiving the gas mixture having the gas component with a co-current direct contact cooling chamber, receiving a cryogenic liquid with the co-current direct contact cooling chamber, and mixing the gas mixture and the cryogenic liquid in the co-current direct contact cooling chamber. The method also includes desublimating the gas component by direct contact of the gas component and the cryogenic liquid and forming a mixture of solid particles of the gas component and fluids remaining after the desublimating and separating the solid particles of the gas component from the mixture of solid particles of the gas component and the fluids remaining after the desublimating using a separator to capture the gas component from the gas mixture.

### BRIEF DESCRIPTION OF THE DRAWINGS

The following descriptions should not be considered limiting in any way. With reference to the accompanying drawings, like elements are numbered alike:

FIG. 1 depicts aspects of an embodiment of a cryogenic carbon capture system;

FIG. 2 depicts further aspects of the cryogenic carbon capture system;

FIG. 3 depicts aspects of a path through a phase diagram that the cryogenic carbon capture system follows;

FIG. 4 depicts aspects of an embodiment of a direct contact cooling chamber; and

FIG. 5 is a flow chart for a method for capturing carbon from a post-combustion gas.

### DETAILED DESCRIPTION

A detailed description of one or more embodiments of the disclosed apparatus and method are presented herein by way of exemplification and not limitation with reference to the figures.

Disclosed are apparatuses and methods for capturing carbon dioxide (CO₂) from a post-combustion gas, generally referred to as a flue gas, using a cryogenic carbon capture system. The cryogenic carbon capture system uses a cryogenic liquid such as liquid nitrogen to desublimate the CO₂ in the flue gas by direct contact of the cryogenic liquid with the CO₂ in the flue gas. The term “desublimate” and the like refer to the process of cooling atoms or molecules in a gas to change the phase from gas to solid. The desublimation of the CO₂ is performed in a direct contact cooling chamber where solid particles of CO₂ are formed. A solid-fluid separator separates the solid CO₂ particles from the surrounding fluid having the cryogenic liquid and lean flue gas components (i.e., flue gas components having reduced CO₂). The solid CO₂ particles may be warmed and pressurized to be in a liquid phase and pumped into a pipeline for transportation to a CO₂ storage facility. The flue gas may be conditioned prior to entering the direct contact cooling chamber by lowering its temperature using the cold material exiting the solid-fluid separator as discussed further below.

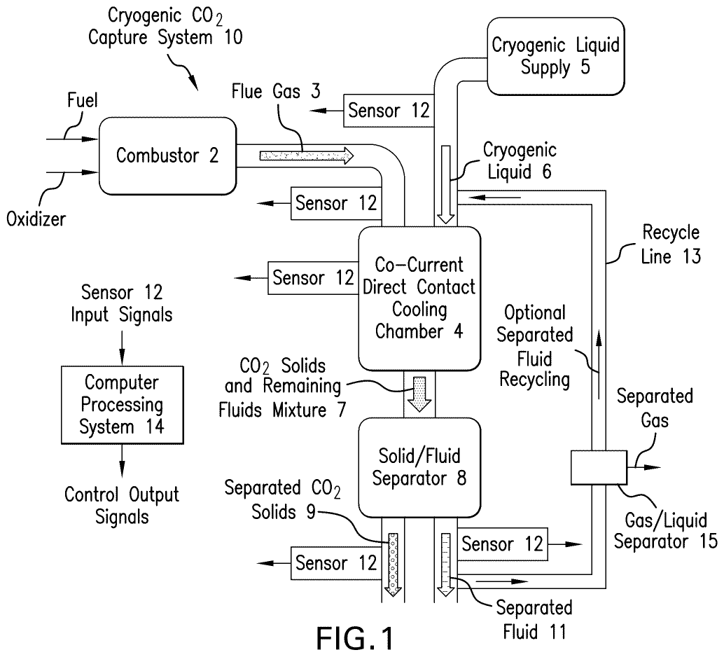

FIG. 1 depicts aspects of an embodiment of a cryogenic carbon capture system (CCCS) 10. A location in a component where a material exits the component may be referred to as an output or output port while a location in the component where a material enters the component may be referred to as an input or input port. Parallel lines at inputs and outputs of illustrated components represent a conduit such as a pipe or duct work configured to contain and direct flow of a material within. The CCCS 10 includes a combustor 2 that discharges a flue gas 3, which contains CO₂ resulting from combustion, into a co-current direct contact cooling chamber 4. Non-limiting embodiments of the combustor 2 include a fossil-fueled boiler, a fossil-fueled engine of some type, and an industrial gas emitting process (e.g., cement industry process). Other types of combustors may also be used. The co-current direct contact cooling chamber 4 is also coupled to a cryogenic liquid supply 5 that supplies cryogenic liquid 6 to the direct contact cooling chamber 4. In one or more embodiments, the cryogenic liquid 6 is liquid nitrogen. Other cryogenic liquids 6 may also be used such as a mixture of different components. For example, in a non-limiting embodiment a mixture of liquid nitrogen and liquid oxygen may be used. The term “co-current” relates to the flue gas 3 and the cryogenic liquid 6 flowing in the same direction in the co-current direct contact cooling chamber 4 such as both flowing from top to bottom in a non-limiting example. The co-current direct contact cooling chamber 4 is configured to desublimate the CO₂ in the flue gas 3 and form solid particles of the CO₂. The desublimation results by cooling the CO₂ to a temperature low enough (according to the phase diagram of the CO₂) to cause the desublimation by direct contact of the cryogenic liquid 6 with the flue gas 3 and thus the CO₂. The direct contact results from the mixing of the cryogenic liquid 6 with the flue gas 3. It can be appreciated that it would be advantageous for the flue gas 3 to be dehydrated before being cooled using one or more devices or methods known in the art to avoid ice formation.

Still referring to FIG. 1, the direct contact cooling chamber 4 further coupled to a solid/fluid separator 8 configured to separate solid particles from a mixture of the solid particles and a fluid. The solid/fluid separator 8 is configured to receive a mixture 7 of the solid particles of CO₂ and the fluid remaining after the desublimation process. The solid/fluid separator 8 is also configured to provide a discharge of separated CO₂ particles 9 such as through a first discharge port and to provide a discharge of separated fluid 11 such as through a second discharge port. The solid/fluid separator 8 can work using any of the separation principles known in the art such as relying on the difference in densities between the CO₂ solid particles and the fluid remaining after the desublimation. Non-limiting examples of separation techniques include settling and centrifugal separation. Other techniques may also be used.

The separated fluid 11 may still be very cold after exiting the solid/fluid separator 8, accordingly the separated fluid 11 can be recycled through the co-current direct contact cooling chamber 4 using a recycle line 13 coupled to an output line conveying the separated fluid 11 and coupled to an input line conveying the cryogenic liquid to the direct contact cooling chamber 4. A gas/liquid separator 15 may also be added to recycle only the liquid phase to the co-current direct contact cooling chamber 4. In one or more embodiments, a refrigeration unit (not shown) may be coupled to the recycle line 13 and dedicated to cool the separated fluid 11 as needed.

As illustrated in FIG. 1, various sensors 12 may be distributed throughout the cryogenic carbon capture system 10 to monitor operation of the cryogenic carbon capture system 10. Non-limiting embodiments of the sensors 12 include temperature sensors, pressure sensors, flow sensors, level sensors, image sensors, infra-red image sensors, vibration sensors, and accelerometers. The sensors 12 can provide input signals to a computer processing system 14 for processing the input signals such as for monitoring operation of the CCCS 10 or displaying sensed values of parameters. In addition, the computer processing system 14 can perform a control function by controlling actuators for various components such as valves (not shown) in pipelines or dampers (not shown) in ducts to operate the cryogenic carbon capture system 10 in a desired manner. The cryogenic carbon capture system 10 may also include various material motivators such as pumps depending on the layout of components in the system 10.

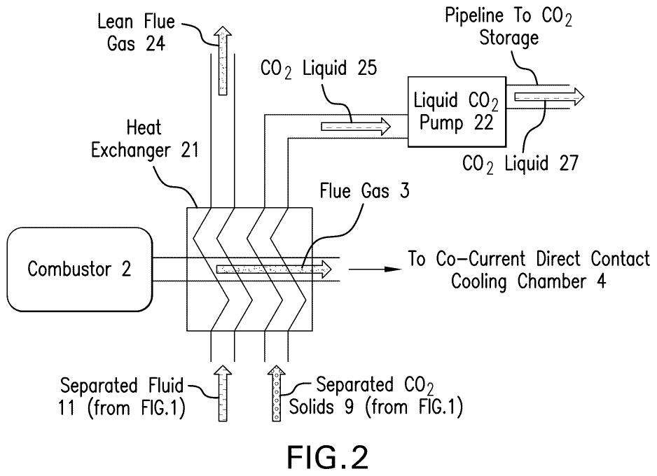

FIG. 2 depicts further aspects of the cryogenic carbon capture system 10. In the embodiment of FIG. 2, the flue gas 3 is conditioned by lowering its temperature prior to entering the direct contact cooling chamber 4 using a heat exchanger 21. The CO₂ in t he separated CO₂ solid particles 9 are also conditioned for transportation in the embodiment of FIG. 2. The separated CO₂ solids 9 flow through one flow path in the heat exchanger 21 and the separated fluids 11 flow through another flow path in the heat exchanger 21. The flow paths in the heat exchanger 21 are separate from each other. The separated CO₂ solids 9 are heated by the flue gas 3 in the heat exchanger 21 and change state to a liquid state according to the known phase diagram for CO₂. It is recognized that the CO₂ solids 9 need to be pressurized first before going to the liquid phase otherwise it will go to gas phase, which could also be an option. A liquid CO₂ 25 exits the heat exchanger 21 at a certain pressure and that pressure may be increased by a liquid CO₂ pump 22 in order for a liquid CO₂ 27 that is discharged from the liquid CO₂ pump 22 to be at a pressure to enter a pipeline leading to a CO₂ storage facility or for its use in other processes. In embodiments where the CO₂ exiting the heat exchanger 21 is in a gas phase, the device 22 may represent a compressor for compressing the gas to a pressure to enter a pipeline leading to a CO₂ storage facility or for its use in other processes. The separated fluids 11 are also heated by the flue gas in the heat exchanger 21 and change state to a gas state (only if liquid was present) that exits the heat exchanger as a lean flue gas 24. The lean flue gas 24 refers to flue gas that is depleted of CO₂ and mixed with the cryogenic liquid 6 that has changed state to a gas. The lean flue gas 24 may be released to the atmosphere. The conditioning of the flue gas 3 and the CO₂ in the separated CO₂ solid particles 9 may be implemented using other apparatus and methods.

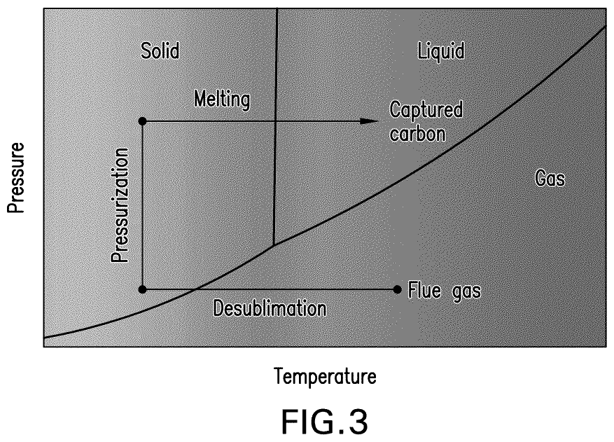

FIG. 3 illustrates a path the CO₂ undergoes in changes in state as it undergoes the process of being removed from the flue gas 3 in one or more embodiments. The path starts with the CO₂ being a gaseous state in the flue gas 3. The CO₂ then undergoes desublimation in the co-current direct contact cooling chamber 4 and transforms to a solid state. Finally, the CO₂ melts and transforms to a liquid state where the liquid can be transported for storage. There are different options for the process by which the CO₂ changes state. In one option, the solid CO₂ is heated with the flue gas and goes to gas phase. In another option, the co-current direct contact cooling chamber 4 is operated under pressure such that when the solid CO₂ is heated up, it turns into liquid phase. In yet another option, a device such as a slurry pump (not shown) in a non-limiting example is used to increase pressure downstream of the co-current direct contact cooling chamber 4. As an alternative scheme, the flue gas can be compressed before being cooled down by the streams exiting the co-current direct contact cooling chamber 4 to partly liquify the CO₂ that can be recovered through a gas/liquid separator. The partially depleted flue gas can either be expanded to make it colder or the co-current direct contact cooling chamber 4 can be operated under pressure. A pump (not shown) coupled to the co-current direct contact cooling chamber 4 for pumping the cryogenic fluid 6 into the co-current direct contact cooling chamber 4 may be used to maintain a selected pressure for operation of the co-current direct contact cooling chamber 4.

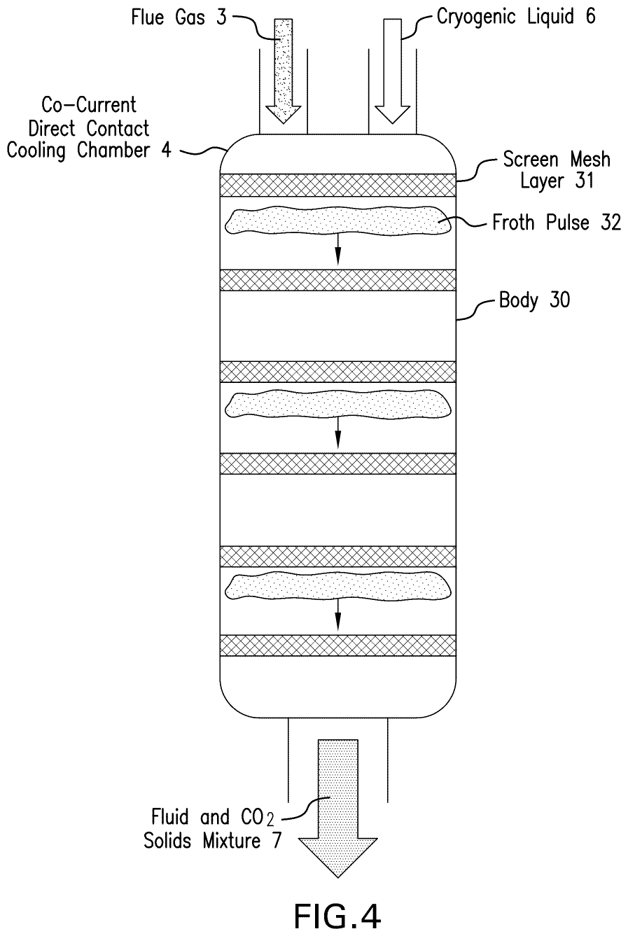

FIG. 4 depicts aspects of an embodiment of the co-current direct contact cooling chamber 4. In the embodiment of FIG. 4, a series of screen mesh layers 31 are stacked in a body 30 of the direct contact cooling chamber 4. Each screen mesh layer 31 contains several openings, and is separated a selected distance from adjacent screen mesh layers 31. When the flue gas 3 and the cryogenic liquid 6 pass through the co-current direct contact cooling chamber 4, the screen mesh layers 31 cause a spontaneous froth pulse 32 of the cryogenic liquid 6 by holding and releasing the fluid in bursts. Note that the term “froth” relates to a mixture of gas and liquid. Since there are multiple screen mesh layers 31, multiple froth pulses 32 are generated. Each froth pulse 32 flows downward (i.e., towards an output of chamber 4) at velocity V_{fp}. The froth pulse 32 is made of many micro-bubbles that increase the effective surface area of the cryogenic liquid 6 and thus increase the rate of heat transferred from the flue gas 3 to the cryogenic liquid 6. The flue gas 3 flows downward at velocity V_{g}. V_{g} is generally greater than V_{fp} so that the flue gas will interact with several froth pulses 32 as the gas traverses the body 30. The interaction of the flue gas 3 with several froth pulses 32 also greatly increases the rate of heat transferred from the flue gas 3 to the cryogenic liquid 6. The CO₂ in the flue gas 3 forms solid particles due to phase change resulting from the cooling. The interaction of the flue gas 3 as the solid particles are being formed results in the size of the solid particles being smaller than openings of the screen mesh in the screen mesh layers 31 allowing the process to continue without clogging. In one or more embodiments, the direct contact cooling chamber 4 is implemented using a Regenerative Froth Contactor (RFC) available from Industrial Climate Solutions of Calgary, Canada.

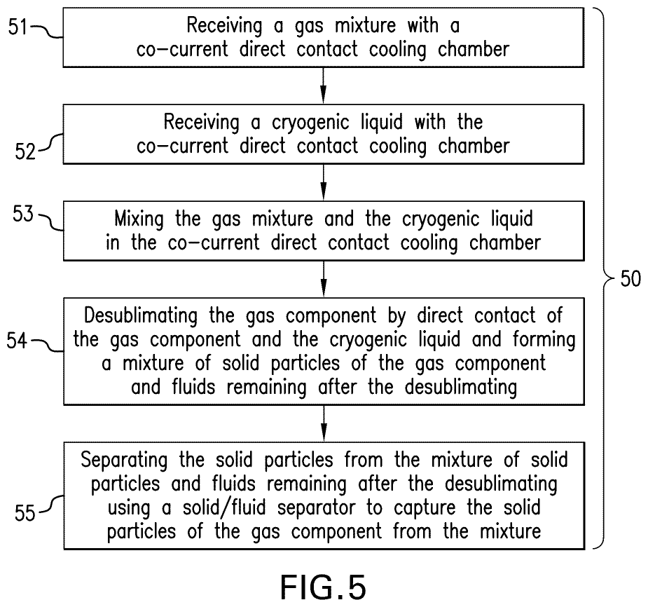

FIG. 5 is a flow chart for a method 50 for capturing a gas component from a gas mixture. Block 51 calls for receiving the gas mixture with a co-current direct contact cooling chamber. In one or more embodiments, the gas mixture is a post-combustion gas or flue gas. In one or more embodiments, the gas component is carbon dioxide (CO₂).

Block 52 calls for receiving a cryogenic liquid with the co-current direct contact cooling chamber. In one or more embodiments, the cryogenic liquid is liquid nitrogen (N₂).

Block 53 calls for mixing the gas mixture and the cryogenic liquid in the co-current direct contact cooling chamber. The mixing of the gas mixture and the cryogenic liquid results in direct contact of the gas mixture with the cryogenic liquid and the resulting cooling of the gas component. In one or more embodiments, the co-current direct contact cooling chamber includes a body enclosing a series of screen mesh layers through which the gas mixture and the cryogenic liquid flow.

Block 54 calls for desublimating the gas component by direct contact of the gas component with the cryogenic liquid and forming a mixture of solid particles of the gas component and fluids remaining after the desublimation.

Block 55 calls for separating the solid particles of the gas component from the mixture of solid particles and fluids remaining after the desublimation using a separator to capture the solid particles of the gas component from the mixture.

The method 50 may also include generating a series of migrating froth pulses of the cryogenic liquid in the co-current direct contact cooling chamber where the co-current direct contact cooling chamber includes a series of screen mesh layers disposed in a chamber body.

The apparatuses and methods disclosed herein for removing a gas component from a gas mixture provide several advantages. One advantage is that the disclosure avoids the use of a solvent in a chemical reaction, solvent degradation, and atmospheric emissions of harmful components. Another advantage is that the removed gas component can be removed in the liquid phase and pumped into a pipeline for transportation and storage whereas in solvent-based processes the gas component is recovered from the solvent in the gas phase and thus requires compression for transportation and storage. Compressors use significantly more energy than pumps for moving the same mass. Yet another advantage is that the disclosure provides up to 99% of gas component (e.g., CO₂) capture with relatively low capture costs and parasitic loads. Yet another advantage is that the co-current direct contact cooling chamber provides for solid particles flowing through a column formed by the chamber without clogging in comparison to prior art counter-current columns. Yet another advantage is that the CO₂ is recovered at high purity. Yet another advantage is that the process can rely solely on electricity with no need for steam.

In support of the teachings herein, various analysis components may be used, including a digital and/or an analog system. For example, the sensors 12, the computer processing system 14, and any supporting system may include digital and/or analog systems. The system may have components such as a processor, storage media, memory, input, output, communications link (wired, wireless, optical or other), user interfaces (e.g., a display or printer), software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a non-transitory computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Set forth below are some embodiments of the foregoing disclosure:

Embodiment 1: An apparatus for capturing a gas component from a gas mixture, the apparatus including a co-current direct contact cooling chamber configured to form solid particles of the gas component by direct contact of a cryogenic liquid with the gas mixture, the co-current direct contact cooling chamber being configured to receive the gas mixture from a source of the gas mixture and to receive the cryogenic liquid from a supply of the cryogenic liquid, and a separator coupled to an output of the co-current direct contact cooling chamber and configured to separate the solid particles of the gas component from a fluid mixture exiting the co-current direct contact cooling chamber with the solid particles of the gas component to capture the gas component from the gas mixture.

Embodiment 2: The apparatus according to any previous embodiment, wherein the gas component comprises carbon dioxide and the gas mixture comprises a post-combustion gas.

Embodiment 3: The apparatus according to any previous embodiment, wherein source of the gas mixture comprises at least one of a fossil-fueled boiler, a fossil-fueled engine, or an industrial process.

Embodiment 4: The apparatus according to any previous embodiment, wherein the cryogenic liquid comprises liquid nitrogen.

Embodiment 5: The apparatus according to any previous embodiment, wherein the co-current direct contact cooling chamber comprises a body containing a series of screen mesh layers separated from each other and configured to spontaneously generate a series of froth pulses.

Embodiment 6: The apparatus according to any previous embodiment, wherein the series of froth pulses travels at velocity V_{fp} through the series of screen mesh layers and the gas mixture travels at velocity V_{g} through the series of screen mesh layers with V_{g} being greater than V_{fp}.

Embodiment 7: The apparatus according to any previous embodiment, further including a recycle line coupled to an output of the separator configured to discharge separated fluid and wherein the recycle line is configured to input the cryogenic liquid in an input of the direct contact cooling chamber.

Embodiment 8: The apparatus according to any previous embodiment, further including a heat exchanger having a first path coupled to a conduit conveying the solid particles of the gas component exiting the separator and a second path coupled to a conduit conveying the gas mixture and optionally a third path coupled to a conduit conveying a fluid exiting the separator.

Embodiment 9: The apparatus according to any previous embodiment, further including at least one of a pump coupled to a conduit conveying the gas component separated in a liquid phase or a compressor coupled to a conduit conveying the separated gas component in a gas phase.

Embodiment 10: The apparatus according to any previous embodiment, further including one or more sensors distributed about the apparatus and configured to sense a property of at least one of the apparatus or a material disposed in the apparatus.

Embodiment 11: The apparatus according to any previous embodiment, further including a computer processing system in communication with the one or more sensors and configured to monitor operation of the apparatus.

Embodiment 12: A method for capturing a gas component from a gas mixture, the method includes receiving the gas mixture comprising the gas component with a co-current direct contact cooling chamber, receiving a cryogenic liquid with the co-current direct contact cooling chamber, mixing the gas mixture and the cryogenic liquid in the co-current direct contact cooling chamber, desublimating the gas component by direct contact of the gas component and the cryogenic liquid and forming a mixture of solid particles of the gas component and fluids remaining after the desublimating, and separating the solid particles of the gas component from the mixture of solid particles of the gas component and the fluids remaining after the desublimating using a separator to capture the gas component from the gas mixture.

Embodiment 13: The method according to any previous embodiment wherein the gas component comprises carbon dioxide and the gas mixture comprises a post-combustion gas.

Embodiment 14: The method according to any previous embodiment wherein the mixing is performed under a selected pressure.

Embodiment 15: The method according to any previous embodiment wherein the direct contact cooling chamber is a co-current direct contact cooling chamber comprising a body containing a series of screen mesh layers separated from each other and configured to spontaneously generate a series froth pulses and the method further comprises generating the series of froth pulses that travels through the series of screen mesh layers.

Embodiment 16: The method according to any previous embodiment wherein the series of froth pulses travels at velocity V_{fp} through the series of screen mesh layers and the gas mixture travels at velocity V_{g} through the series of screen mesh layers with V_{g} being greater than V_{fp}.

Embodiment 17: The method according to any previous embodiment further comprising recycling the fluids remaining after the desublimating to an input of the direct contact cooling chamber.

Embodiment 18: The method according to any previous embodiment further comprising cooling the gas mixture prior to the gas mixture entering the direct contact cooling chamber.

Embodiment 19: The method according to any previous embodiment wherein the cooling is performed by a heat exchanger that receives at least one of separated solid particles or the fluids remaining after the desublimating as a coolant.

Elements of the embodiments have been introduced with either the articles “a” or “an.” The articles are intended to mean that there are one or more of the elements. The terms “including” and “having” and the like are intended to be inclusive such that there may be additional elements other than the elements listed. The conjunction “or” when used with a list of at least two terms is intended to mean any term or combination of terms. The term “configured” relates one or more structural limitations of a device that are required for the device to perform the function or operation for which the device is configured. The term “coupled” relates to being directly coupled or indirectly coupled using an intermediate component.

The flow diagram depicted herein is just an example. There may be many variations to this diagram or the steps (or operations) described therein without departing from the scope of the invention. For example, operations may be performed in another order or other operations may be performed at certain points without changing the specific disclosed sequence of operations with respect to each other. All of these variations are considered a part of the claimed invention.

The disclosure illustratively disclosed herein may be practiced in the absence of any element which is not specifically disclosed herein.

While one or more embodiments have been shown and described, modifications and substitutions may be made thereto without departing from the scope of the invention. Accordingly, it is to be understood that the present invention has been described by way of illustrations and not limitation.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for capturing a gas component from a gas mixture, the apparatus comprising:
a co-current direct contact cooling chamber configured to form solid particles of the gas component by direct contact of a cryogenic liquid with the gas mixture, the co-current direct contact cooling chamber being configured to receive the gas mixture from a source of the gas mixture and to receive the cryogenic liquid from a supply of the cryogenic liquid; and
a separator coupled to an output of the co-current direct contact cooling chamber and configured to separate the solid particles of the gas component from a fluid mixture exiting the co-current direct contact cooling chamber with the solid particles of the gas component to capture the gas component from the gas mixture.

2. The apparatus according to claim 1, wherein the gas component comprises carbon dioxide and the gas mixture comprises a post-combustion gas.

3. The apparatus according to claim 2, wherein source of the gas mixture comprises at least one of a fossil-fueled boiler, a fossil-fueled engine, or an industrial process.

4. The apparatus according to claim 1, wherein the cryogenic liquid comprises liquid nitrogen.

5. The apparatus according to claim 1, wherein the co-current direct contact cooling chamber comprises a body containing a series of screen mesh layers separated from each other and configured to spontaneously generate a series of froth pulses.

6. The apparatus according to claim 5, wherein the series of froth pulses travels at velocity V_{fp} through the series of screen mesh layers and the gas mixture travels at velocity V_{g} through the series of screen mesh layers with V_{g} being greater than V_{fp}.

7. The apparatus according to claim 1, further comprising a recycle line coupled to an output of the separator configured to discharge separated fluid and wherein the recycle line is configured to input the cryogenic liquid in an input of the direct contact cooling chamber.

8. The apparatus according to claim 1, further comprising a heat exchanger having a first path coupled to a conduit conveying the solid particles of the gas component exiting the separator and a second path coupled to a conduit conveying the gas mixture and optionally a third path coupled to a conduit conveying a fluid exiting the separator.

9. The apparatus according to claim 8, further comprising at least one of a pump coupled to a conduit conveying the gas component separated in a liquid phase or a compressor coupled to a conduit conveying the separated gas component in a gas phase.

10. The apparatus according to claim 1, further comprising one or more sensors distributed about the apparatus and configured to sense a property of at least one of the apparatus or a material disposed in the apparatus.

11. The apparatus according to claim 10, further comprising a computer processing system in communication with the one or more sensors and configured to monitor operation of the apparatus.

12. A method for capturing a gas component from a gas mixture, the method comprising:
receiving the gas mixture comprising the gas component with a co-current direct contact cooling chamber;
receiving a cryogenic liquid with the co-current direct contact cooling chamber;
mixing the gas mixture and the cryogenic liquid in the co-current direct contact cooling chamber;
desublimating the gas component by direct contact of the gas component and the cryogenic liquid and forming a mixture of solid particles of the gas component and fluids remaining after the desublimating; and
separating the solid particles of the gas component from the mixture of solid particles of the gas component and the fluids remaining after the desublimating using a separator to capture the gas component from the gas mixture.

13. The method according to claim 12, wherein the gas component comprises carbon dioxide and the gas mixture comprises a post-combustion gas.

14. The method according to claim 12, wherein the mixing is performed under a selected pressure.

15. The method according to claim 12, wherein the direct contact cooling chamber is a co-current direct contact cooling chamber comprising a body containing a series of screen mesh layers separated from each other and configured to spontaneously generate a series froth pulses and the method further comprises generating the series of froth pulses that travels through the series of screen mesh layers.

16. The method according to claim 15, wherein the series of froth pulses travels at velocity V_{fp} through the series of screen mesh layers and the gas mixture travels at velocity V_{g} through the series of screen mesh layers with V_{g} being greater than V_{fp}.

17. The method according to claim 12, further comprising recycling the fluids remaining after the desublimating to an input of the direct contact cooling chamber.

18. The method according to claim 12, further comprising cooling the gas mixture prior to the gas mixture entering the direct contact cooling chamber.

19. The method according to claim 18, wherein the cooling is performed by a heat exchanger that receives at least one of separated solid particles or the fluids remaining after the desublimating as a coolant.
